(19) United States
(12) Patent Application Publication
(10) Pub. No.: US 2026/0307554 A1
(43) Pub. Date: Oct. 8, 2026

(54) CAR SEAT ARM LOCK INDICATOR

(71) Applicant: Evenflo Company, Inc., Miamisburg, OH (US)

(72) Inventors: Bryan Ray ADAMS, Beavercreek, OH (US); Xiaoyong YANG, Kushan (CN)

(21) Appl. No.: 18/976,017

(22) Filed: Dec. 10, 2024

(51) Int. Cl. B60N 2/26; B60N 2/28

(52) U.S. Cl. CPC B60N 2/268; B60N 2/2821

(57) ABSTRACT

An assembly is provided for securing a car seat within an automobile. The assembly comprises a base having a front, a back and a top extending between the front and the back. The top has a viewing window providing viewing access below the top. An arm is pivotally coupled to the base, and is movable between an open position and a locked position. The assembly includes a cam slidingly held within the base. The cam is moveable between a first position with one end extending into the cavity in the base when the arm is in the open position, and a second position where the cam is moved farther into the base when the arm is in the locked position. The assembly includes locking indicia on the cam that is viewable through the viewing window only when the cam slides into the second position.

### CROSS-REFERENCE TO RELATED APPLICATIONS

This application is related to U.S. patent application Ser. No. ______, entitled “CAR SEAT ARM LOCK INDICATOR,” Attorney Docket No. 42842.423530, filed on even date herewith.

### TECHNICAL FIELD

The present disclosure generally relates to an assembly that indicates a locking condition for an arm on a car seat base.

### BACKGROUND

Traditionally, infants may be transported in infant car seats. In the United States, child car seats are required by law and recommended for children of certain ages or sizes. There are many types of car seats available for purchase. Infant car seats recommended for children under age 1 are typically rear-facing. Many infant car seats include a base that is belted or tethered into the car and a seat that may latch into the base. The base may be secured to the car using the seat belt. An arm is pivotally coupled to the base (sometimes called a “strong arm”). The arm is pivoted away from the base to allow the base to be secured using the seat belt. The arm is then pivoted down, over the seat belt, and is secured or locked in the down position. One issue in this process is positively determining that the arm is properly secured in the locked position relative to the base.

### BRIEF DESCRIPTION OF THE DRAWINGS

The drawings described herein are for illustrative purposes only, are schematic in nature, and are intended to be exemplary rather than to limit the scope of the disclosure.

FIG. 1 is a perspective view of an assembly used as part of an infant transport system.

FIG. 2 is a perspective view of the assembly of FIG. 1, but showing the arm pivoted to an open position.

FIG. 3 is an enlarged view of the locking area.

FIG. 4 is a perspective bottom view of the top shell of the base.

FIG. 5 is an enlarged partial view of the assembly, shown with the top shell of the base hidden from view.

FIG. 6 is a perspective view of the assembly of FIG. 1, shown with the bottom of the base hidden from view.

FIG. 7 is a perspective view of the cam of FIGS. 1-6.

FIG. 8 is a partial perspective view illustrating an alternative configuration for the cam.

FIG. 9 is an enlarged, partial perspective view showing the position of the cam of FIG. 8 when the arm is in the open position.

FIG. 10 is a view similar to FIG. 9, but showing the position of the cam when the arm is in the closed position.

### DETAILED DESCRIPTION

In an example, an assembly is provided for securing a car seat within an automobile. The assembly comprises a base having a front, a back and a top extending between the front and the back. The top has a viewing window providing viewing access below the top. An arm is pivotally coupled to the base, and is movable between an open position and a locked position. The assembly includes a cam slidingly held within the base. The cam is moveable between a first position with one end extending into the cavity in the base when the arm is in the open position, and a second position where the cam is moved farther into the base when the arm is in the locked position. The assembly includes locking indicia on the cam that is viewable through the viewing window only when the cam slides into the second position.

The above features and advantages and other features and advantages of the present teachings are readily apparent from the following detailed description of the modes for carrying out the present teachings when taken in connection with the accompanying drawings.

In some aspects, at a high-level, an assembly is provided for securing a car seat within an automobile. As used herein and as will be appreciated by those skilled in the art, the term “car seat” encompasses car seats, safety seats, restraints, boosters, and the like for children, infants, and toddlers and the like. In such systems, a base is provided that is secured to the automobile, such as via a seat belt strap or other anchoring mechanisms. The base has a structure that is configured to removably hold a car seat, such that the car seat can be secured to the base for automobile travel, and removed from the base to otherwise transport the infant. The base has an arm (sometimes called a “strong arm”) that is pivotally coupled to the base. When pivoted up to an open position, the arm allows the seat belt of the automobile to be routed through the base, to secure the base to the automobile. The arm is pivoted down and locked into place to further secure the base and ready it for transport. It would be desirable for a user to know that the arm is properly pivoted down and completely locked into place. If the arm is not fully locked in place, for example, the base is not completely secured within the vehicle, resulting in an unsecured car seat that threatens the safety of a child.

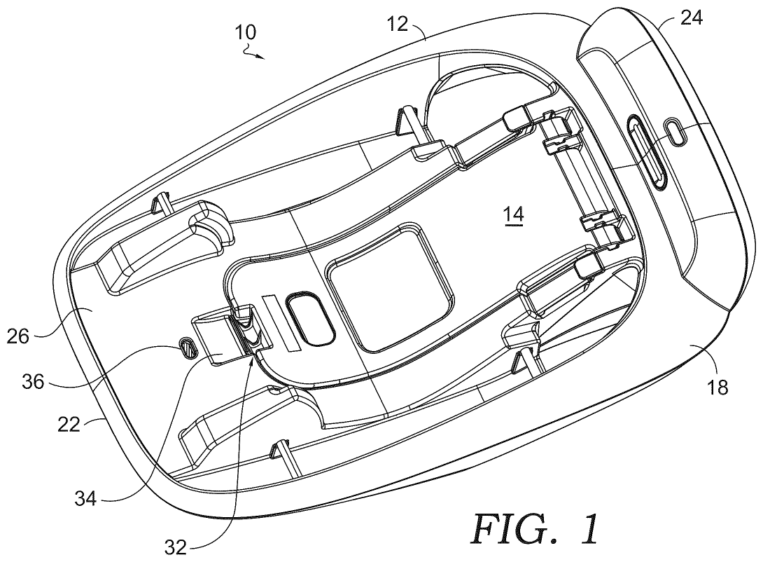

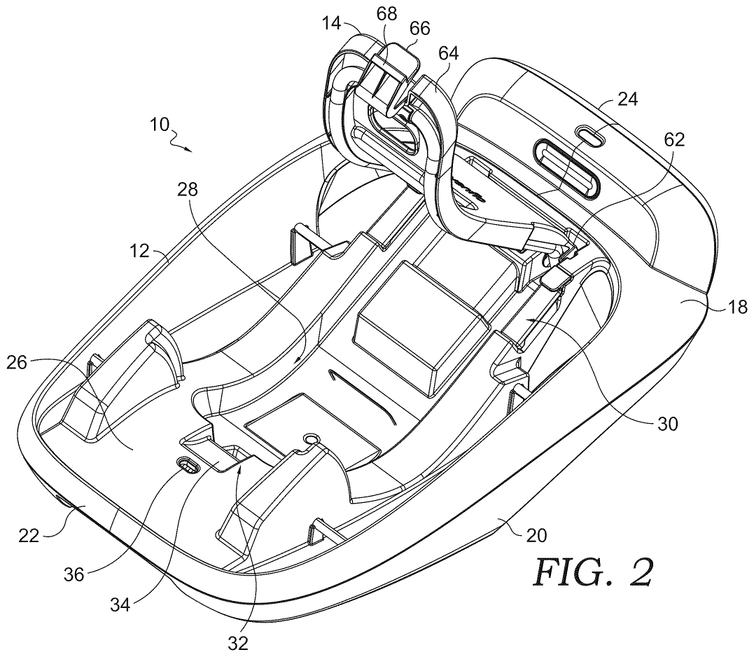

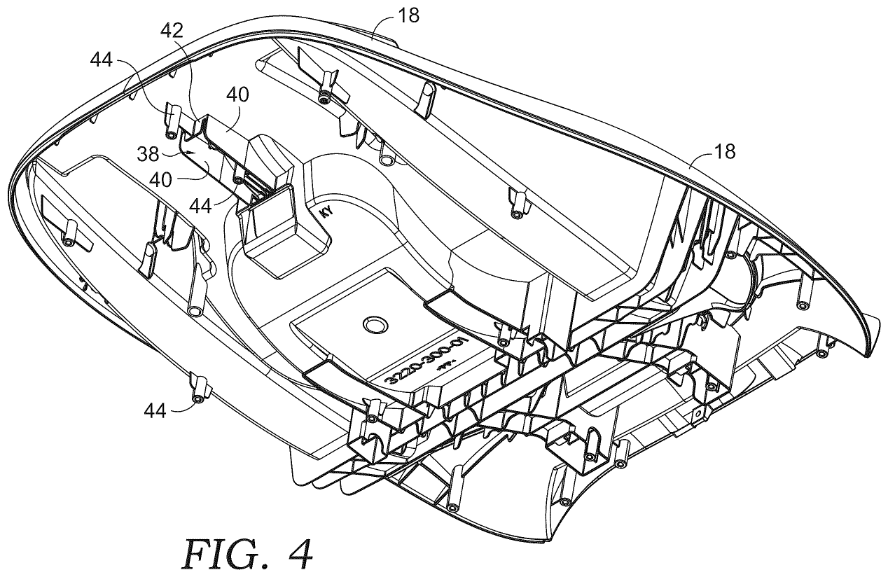

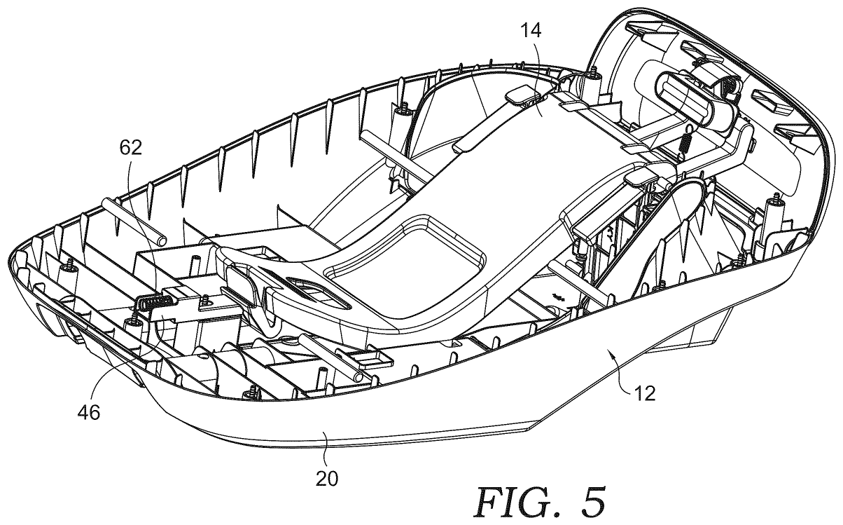

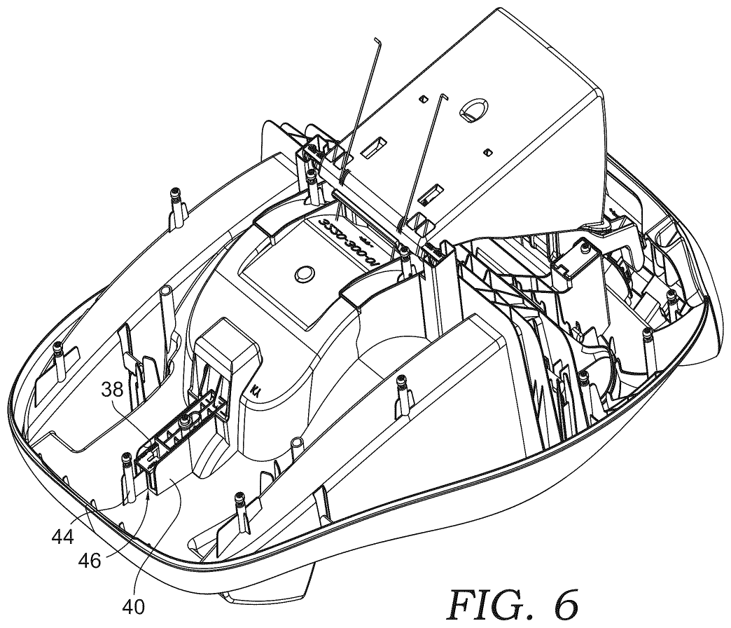

Referring to the drawings, wherein like reference numbers refer to like components, FIGS. 1-10 depict an assembly 10 for securing a car seat to the automobile. The assembly 10, in some aspects, includes a base 12 and an arm 14 pivotally coupled to the base 12. In some aspects, the base 12 may have a top shell 18 (as best seen in FIGS. 1 and 4) and a bottom shell 20 (as best seen in FIGS. 2 and 5). The top shell 18 is fixedly coupled to the bottom shell 20. In some aspects, the top shell 18 and the bottom shell 20 are molded plastic components. The base 12 can be seen to have a front 22, a back 24, and a top surface 26 extending from the front 22 to the back 24 (the top surface 26 being the upward-facing surface(s) of the top shell 18). As seen in FIG. 2, with the arm 14 pivoted to an open position, the top surface 26 of the base 12 defines a cavity 28 shaped to accommodate the arm 14 to allow the arm 14 to be recessed within the cavity 28 when the arm 14 is in the locked position of FIG. 1 such that the arm 14 is substantially flush with top surface 26. The base 12 (and specifically the top shell 18) also includes a belt path 30 that is shaped and sized to accommodate a seat belt from the vehicle. Near the front of the cavity 28, the top shell 18 includes a locking area 32. In some aspects, the locking area 32 includes a locking ledge 34 that is recessed to allow the arm to be locked and released, as further described below. The top shell 18 also includes a viewing window 36 that provides visible access below the top shell 18. In some aspects, the viewing window 36 is located in front of the locking area 32. In this position, the viewing window 36 can be seen with the arm 14 in either the locked position of FIG. 1 or the open position of FIG. 2. Further, in some aspects, the viewing window 36 is covered with a clear material, such that the portion of the top shell 18 containing the viewing window 36 is sealed or covered to protect indicia therein without obscuring visibility. In other aspects, the viewing window 36 may take the form of an opening in the top shell 18 (without a covering). As best seen in FIG. 4, the top shell 18 may include an integrally formed channel 38. In some aspects, the channel 38 is formed with side walls 40 that extend downwardly from the top surface 26. The channel 38 may also include a front wall 42. At least a portion of the channel 38 is located below the viewing window 36. FIG. 4 also shows a number of connection posts 44 that are used to couple the top shell 18 to the bottom shell 20.

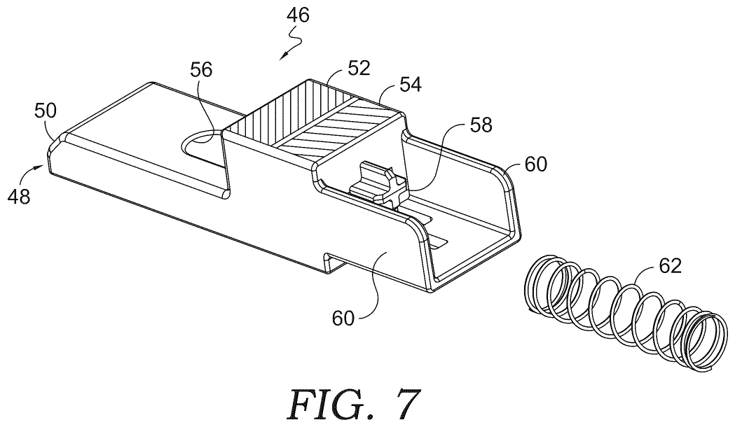

As best seen in FIGS. 5-7, a cam 46 is slidingly held in the channel 38. As best seen in FIG. 7 the cam 46 includes a first end 48 with a surface 50. The surface 50 angles downwardly from the top of the first end 48 toward the bottom of the first end 48. The cam 46 also includes a locking indicia 52 (indicated by the hatched lines). In some aspects, the locking indicia 52 could be a color, such as green, but other visible indicia could also be used for the locking indicia 52. Further, in some aspects, the cam 46 also includes an open indicia 54 (indicated by reverse hatched lines). In some aspects, the open indicia 54 could be a color (such as red), but other visible indicia could also be used for the open indicia 54. The cam 46 may also include an ovular through-hole 56 that accommodates a corresponding connection post 44 (and a corresponding connector, such as a screw). Further, the cam 46 may include a spring post 58 that protrudes rearward, and a pair of spaced walls 60. The spring post 58 and the walls 60 are used to retain a compression spring 61. The spring 61 is held between the spring post 58, the walls 60 and the front wall 42. The spring post 58 may be shaped and sized to be inserted into the interior of the spring 61, while maintaining the spring 61 in a centered in position relative to along the walls 60, and as parallel to, the length of the corresponding cam 46.

Returning to FIG. 2, the arm 14 has a first end 62 that is pivotally coupled to the base 12. The arm 14 extends from the first end 62 to a second end 64. At the second end 64, the arm 14 includes a hook 66 that is flexibly deformable, such that the hook 66 can move toward and away from the first end 62 as further discussed herein. The hook 66, in some aspects, includes a locking surface 68.

As described above, the arm 14 is moveable between an open position, as shown in FIG. 2, where the arm 14 is pivoted away from the top surface 26, to a locked position, as shown in FIG. 1, where the arm 14 is pivoted down such that the arm 14 nests within the cavity 28. In this locked position, the hook 66 can deform, or bend, toward the first end 62 of the arm 14. This allows the locking surface 68 to clear the locking ledge 34 on the base 12 and be “squeezed” into the locking area 32. For example, when the arm 14 is pivoted toward the base 20, the hook 66 is inserted into the locking area 32, which has dimensions that force the hook 66 to become compressed and to deform relative to a vertex of the hook 66. For example, the hook 66 may comprise a pair of members that meet to form a lower edge having an acute interior angle, wherein the lower edge acts as the vertex (e.g., when viewed in a cross-section). The pair of members are moved closer to one another (making the interior angle smaller) when the hook 66 is inserted into the locking area 32, such that the hook 66 is deformed and the apex is tensioned. As deformed, the hook 66 is held within the locking area 32 in the locked position by the outward force of the members of the hook 66 contacting and pressing against the locking area 32. In other words, the hook 66 has a structural rigidity in a resting state, but can be deformed by the application of force, when forced into the locking area 32 by a downward force. Accordingly, when the arm 14 is instead pivoted away from the base 12 the hook 66 is freed of the locking area 32 and the flexibly deformable characteristic of the hook 66 releases the tensioning at the vertex when in the unlocked position, and the members return to a resting state.

Once the locking surface 68 is below the locking ledge 34, the arm 14 is in a locked position, until a user manipulates the hook 66 to release the arm 14 from the locked position. With the arm 14 in the open position of FIG. 2, the cam 46 is biased toward the back 24 of the base 12 by the spring 61. In this first position of the cam 46, the first end 48 of the cam 46 extends into the cavity 28. In this first position of the cam 46, the locking indicia 52 is not viewable through the viewing window 36 (because the cam 46 is biased into a position where the locking indicia 52 are not aligned with the viewing window 36). In some aspects, with the arm 14 in the open position of FIG. 2, the open indicia 54 is viewable through the viewing window 36, allowing a user to know that the arm 14 is in an open or unlocked position. As the arm 14 is lowered into the locked position of FIG. 1, the forward portion of the hook 66 contacts the surface 50 on the first end 48 of the cam 46. This contact linearly translates the cam 46 toward the front 22 of the base 12, moving the cam 46 farther into the base 12 so that the arm 14 fits into the cavity 28 and the hook 66 fits into the locking area 32. With the arm 14 in the locked position of FIG. 1, the cam 46 is moved by the hook 66 on the second end 64 of the arm 14 to a position where the locking indicia 52, as connected to and horizontally translatable with the cam 46, aligns with the viewing window 36. This now-visible locking indicia 52 allows a user to know that the arm 14 is in the locked position and fully secured.

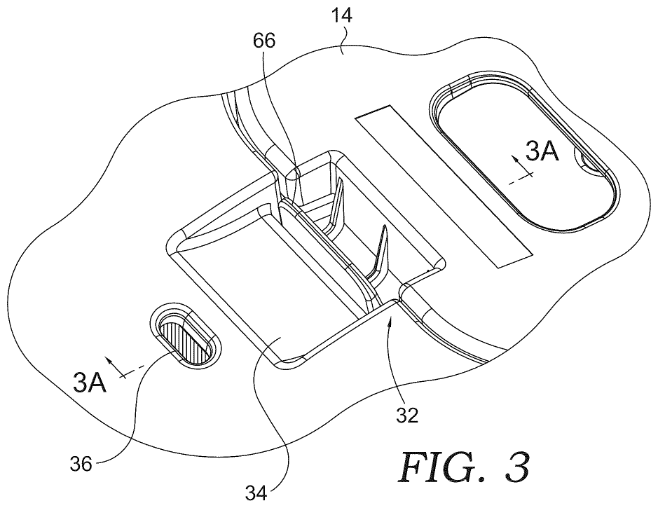

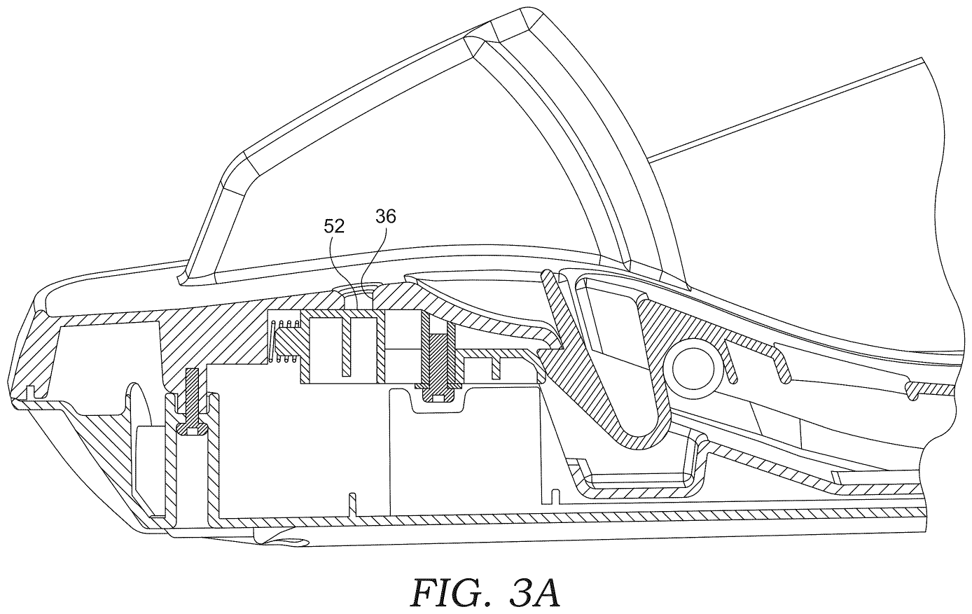

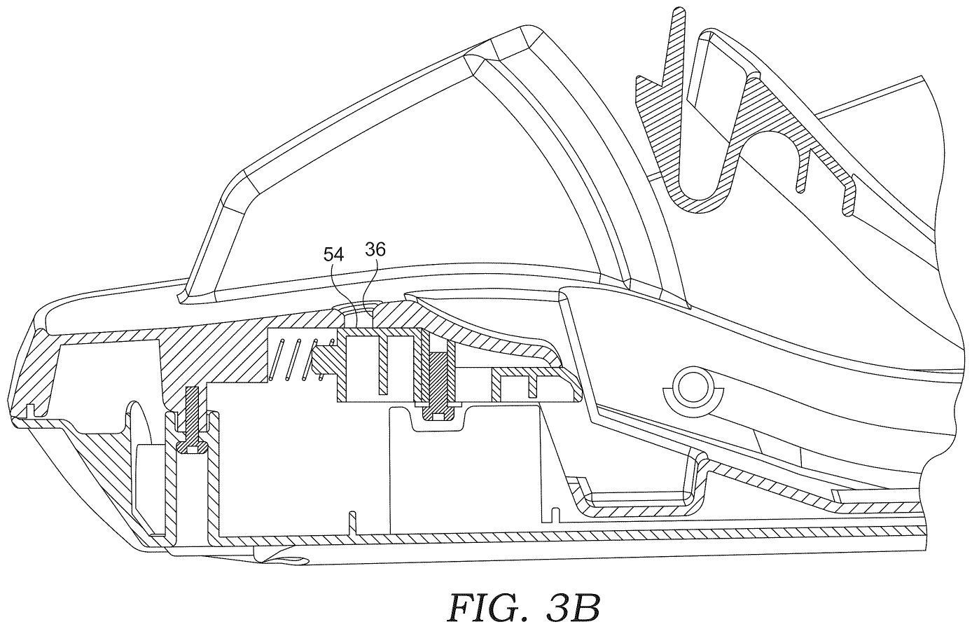

In order to move the arm 14 from the locked position into an unlocked position, a user may grasp and press a portion of the hook 66 that is accessible above the locking area 32 as the portion is exposed by the recessed locking ledge 24. The portion of the hook 66 may be pressed toward the back 24 (to tension the vertex and reducing the width of the hook) and pulled upward to slip the hook 66 from the locking area 32 and thus free the arm 14. Once the arm 14 clears the locking area, the cam 46 moves, via the spring 61, to the position shown in FIG. 3A, with the open indicia 54 aligned with the viewing window 36.

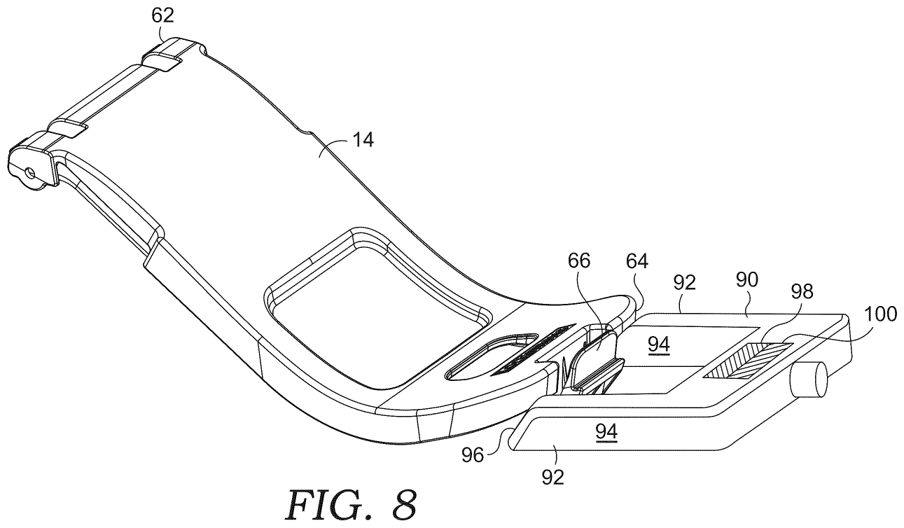

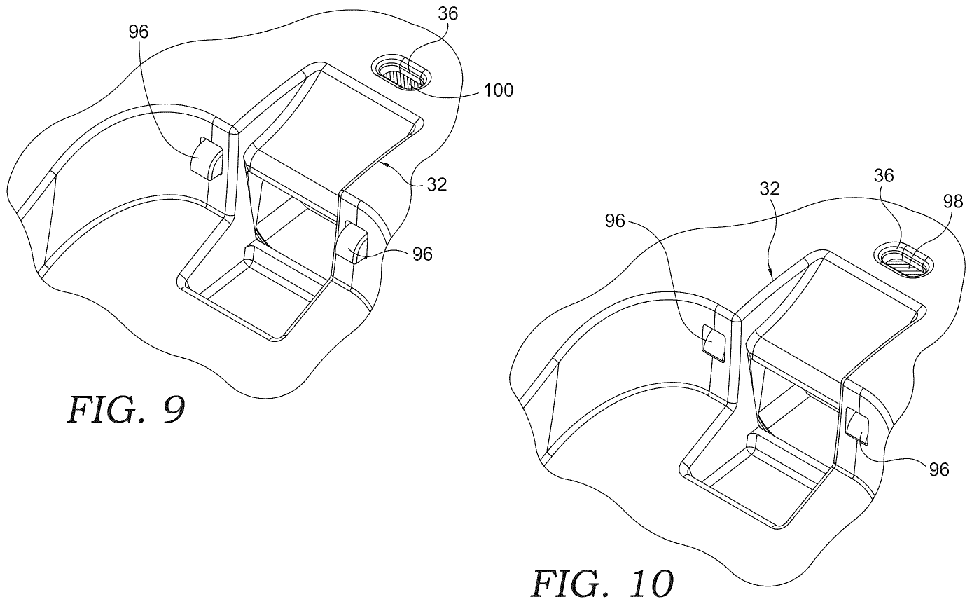

In another aspect, as seen in FIGS. 8-10, an alternative cam 90 is shown. Like the cam 46 described above, the cam 90 is slidingly held within the base 12. As best seen in FIG. 8 the cam 90 includes a bi-furcated first end 92 with two extending legs 94. The outer end of each leg 94 includes a surface 96 that is angled. The surface 96 angles downwardly from the top of the each leg 94 toward the bottom of each leg 94. In one aspect, the legs 94 are spaced apart to span the hook 66 on the arm 14. Like the cam 46, the cam 90 also includes a locking indicia 98 (indicated by the hatched lines). In some aspects, the locking indicia 98 could be a color, such as green, but other visible indicia could also be used for the locking indicia 98. Further, in some aspects, the cam 90 also includes an open indicia 100 (indicated by reverse hatched lines). In some aspects, the open indicia 100 could be a color (such as red), but other visible indicia could also be used for the open indicia 100. Further, the cam 90 may be spring-biased to an extended position (shown in FIG. 9) by a compression spring (not shown). In this aspect, the second end 64 of the arm 14 (rather than the hook 66) contacts the surfaces 96 on the legs 94 when the arm 14 is lowered to the locked position. This downward motion causes the second end 64 (e.g., shown as vertical sidewalls) to slidably contact the angle of the surface 96, pushing the cam 90 inward to tension the compression spring as linearly translating the cam 90 toward the front 22 of the base 12. As such, the cam 90 is moved farther into the base 12 and the arm 14 displaces a portion of the cam 90 that projects into the cavity 28 (when the arm 14 is in the unlocked position) into the base 12 (when the arm is in the locked position). With the arm 14 in the locked position of FIG. 10, the cam 90 is moved by the second end 64 of the arm 14 to a position where the locking indicia 98 aligns with the viewing window 36. This allows a user to know and confirm that the arm 14 is in the locked position.

The above-described assembly 10 allows users to more positively know when the arm 14 is in the locked position, providing greater confidence the assembly 10 is in a proper state for transport of an infant or child.

The following clauses provide example configurations of an assembly for securing a car seat within an automobile as disclosed herein.

Clause 1. An assembly for securing a car seat within an automobile, the assembly comprising: a base, the base having; a front, a back and a top extending between the front and the back; the top defining a cavity and having a viewing window disposed in the top, the viewing window providing viewing access below the top; an arm having a first end and a second end distal from the first end, the first end pivotally coupled to the base, the arm pivotal between an open position with the distal end of the arm pivoted away from the top of the base, and a locked position with the distal end of the arm pivoted to abut the base; a cam slidingly held within the base adjacent the cavity, the cam having a first end and a second end, the cam moveable between a first position with the first end extending into the cavity in the base, when the arm is in the open position, and a second position wherein the second end is moved farther into the base when the arm is in the locked position; and locking indicia on the cam, the locking indicia viewable through the viewing window only when the cam slides into the second position.

Clause 2. The assembly of clause 1, wherein the distal end of the arm contacts the first end of the cam when the arm is in the locking position, sliding the cam into the second position.

Clause 3. The assembly of any of clauses 1-2, wherein the cam is biased to the first position.

Clause 4. The assembly of any of clauses 1-3, further comprising open indicia on the cam, the open indicia viewable through the viewing window when the cam is in the first position.

Clause 5. The assembly of any of clauses 1-4, wherein the cam moves into the first position when the arm is in the open position.

Clause 6. The assembly of any of clauses 1-5, wherein the viewing window is located on the top of the base nearer the front of the base than the back of the base.

Clause 7. The assembly of any of clauses 1-6, wherein the viewing window is visible with the arm in either the open position or the locked position.

Clause 8. The assembly of any of clauses 1-7, wherein the first end of the cam is bifurcated, with two spaced apart buttons extending into the cavity with the cam in the first position.

Clause 9. The assembly of any of clauses 1-8, wherein the first end of the cam has an angled surface extending from a top of the first end to a bottom of the first end, and wherein contact of the distal end of the arm with the angled surface moves the cam linearly toward the front end of the base.

Clause 10. An assembly for indicating a locked condition of a strong arm on a car seat base, the assembly comprising: a base having a front, a back and a top extending between the front and the back; the top defining a cavity and having a viewing window disposed in the top, the viewing window providing viewing access below the top; an arm having a first end and a second end distal from the first end, the first end pivotally coupled to the base, the arm pivotal between an open position with the distal end of the arm pivoted away from the top of the base, and a locked position with the distal end of the arm pivoted to abut the base; a cam within the base adjacent the cavity, the cam moveable from a first position with a portion extending into the cavity to a second position where said portion is moved away from the cavity and into the base; and a locking indicia on the cam, the locking indicia viewable through the viewing window only when the cam slides into the second position.

Clause 11. The assembly of clause 10, wherein the base defines a channel within which the cam slides between the first position and the second position.

Clause 12. The system of any of clauses 10-11, wherein the cam is biased to the first position.

Clause 13. The system of any of clauses 10-12, wherein the distal end of the arm moves the cam to the second position when the arm is moved to the locked position.

Clause 14. The system of any of clauses 10-13, further comprising an open indicia on the cam indicating the arm is not in the locked position, the open indicia visible through the viewing window when the cam is not in the second position.

Clause 15. An assembly for indicating a locked condition of a strong arm on a car seat base, the assembly comprising: a viewing window on the base providing viewing access through the base; a strong arm having a first end and a second end distal from the first end, the first end pivotally coupled to the base, the strong arm pivotal between an open position with the distal end of the arm pivoted away from the top of the base, and a locked position with the distal end of the arm pivoted to abut the base; a cam movably coupled within the base adjacent the viewing window, the cam having a first end and a second end, the cam moveable between a first position with the first end extending into the cavity in the base, when the arm is in the open position, and a second position wherein the second end is moved farther into the base when the arm is in the locked position; and locking indicia on the second end of the cam, the locking indicia viewable through the viewing window only when the cam slides into the second position.

Clause 16. The assembly of clause 15, wherein the distal end of the arm contacts the first end of the cam when the arm is in the locking position, translating the cam into the second position.

Clause 17. The assembly of any of clauses 15-16, wherein the cam is spring-biased to the first position.

Clause 18. The assembly of any of clauses 15-17, further comprising open indicia on the cam adjacent the locking indicia, the open indicia viewable through the viewing window when the cam is in the first position.

Clause 19. The assembly of any of clauses 15-18, wherein the spring moves the cam into the first position when the arm is in the open position.

Clause 20. The assembly of any of clauses 15-19, wherein the viewing window is visible with the strong arm in either the open position or the locked position.

To assist and clarify the description of various embodiments, various terms are defined herein. Unless otherwise indicated, the following definitions apply throughout this specification (including the claims). Additionally, all references referred to are incorporated herein in their entirety.

“A”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. As used in the description and the accompanying claims, a value is considered to be “approximately” equal to a stated value if it is neither more than 5 percent greater than nor more than 5 percent less than the stated value. In addition, a disclosure of a range is to be understood as specifically disclosing all values and further divided ranges within the range.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

For consistency and convenience, directional adjectives may be employed throughout this detailed description corresponding to the illustrated embodiments. Those having ordinary skill in the art will recognize that terms such as “above”, “below”, “upward”, “downward”, “top”, “bottom”, etc., may be used descriptively relative to the figures, without representing limitations on the scope of the invention, as defined by the claims.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

While several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed is:

1. An assembly for securing a car seat within an automobile, the assembly comprising:
a base, the base having;
a front, a back and a top extending between the front and the back; the top defining a cavity and having a viewing window disposed in the top, the viewing window providing viewing access below the top;
an arm having a first end and a second end distal from the first end, the first end pivotally coupled to the base, the arm pivotal between an open position with the distal end of the arm pivoted away from the top of the base, and a locked position with the distal end of the arm pivoted to abut the base;
a cam slidingly held within the base adjacent the cavity, the cam having a first end and a second end, the cam moveable between a first position with the first end extending into the cavity in the base, when the arm is in the open position, and a second position wherein the second end is moved farther into the base when the arm is in the locked position; and
locking indicia on the cam, the locking indicia viewable through the viewing window only when the cam slides into the second position.

2. The assembly of claim 1, wherein the distal end of the arm contacts the first end of the cam when the arm is in the locking position, sliding the cam into the second position.

3. The assembly of claim 2, wherein the cam is biased to the first position.

4. The assembly of claim 3, further comprising open indicia on the cam, the open indicia viewable through the viewing window when the cam is in the first position.

5. The assembly of claim 4, wherein the cam moves into the first position when the arm is in the open position.

6. The assembly of claim 5, wherein the viewing window is located on the top of the base nearer the front of the base than the back of the base.

7. The assembly of claim 6, wherein the viewing window is visible with the arm in either the open position or the locked position.

8. The assembly of claim 1, wherein the first end of the cam is bifurcated, with two spaced apart buttons extending into the cavity with the cam in the first position.

9. The assembly of claim 1, wherein the first end of the cam has an angled surface extending from a top of the first end to a bottom of the first end, and wherein contact of the distal end of the arm with the angled surface moves the cam linearly toward the front end of the base.

10. An assembly for indicating a locked condition of a strong arm on a car seat base, the assembly comprising:
a base having a front, a back and a top extending between the front and the back; the top defining a cavity and having a viewing window disposed in the top, the viewing window providing viewing access below the top;
an arm having a first end and a second end distal from the first end, the first end pivotally coupled to the base, the arm pivotal between an open position with the distal end of the arm pivoted away from the top of the base, and a locked position with the distal end of the arm pivoted to abut the base;
a cam within the base adjacent the cavity, the cam moveable from a first position with a portion extending into the cavity to a second position where said portion is moved away from the cavity and into the base; and
a locking indicia on the cam, the locking indicia viewable through the viewing window only when the cam slides into the second position.

11. The assembly of claim 10, wherein the base defines a channel within which the cam slides between the first position and the second position.

12. The assembly of claim 11, wherein the cam is biased to the first position.

13. The assembly of claim 12, wherein the distal end of the arm moves the cam to the second position when the arm is moved to the locked position.

14. The assembly of claim 13, further comprising an open indicia on the cam indicating the arm is not in the locked position, the open indicia visible through the viewing window when the cam is not in the second position.

15. An assembly for indicating a locked condition of a strong arm on a car seat base, the assembly comprising:
a viewing window on the base providing viewing access through the base;
a strong arm having a first end and a second end distal from the first end, the first end pivotally coupled to the base, the strong arm pivotal between an open position with the distal end of the arm pivoted away from the top of the base, and a locked position with the distal end of the arm pivoted to abut the base;
a cam movably coupled within the base adjacent the viewing window, the cam having a first end and a second end, the cam moveable between a first position with the first end extending into the cavity in the base, when the arm is in the open position, and a second position wherein the second end is moved farther into the base when the arm is in the locked position; and
locking indicia on the second end of the cam, the locking indicia viewable through the viewing window only when the cam slides into the second position.

16. The assembly of claim 15, wherein the distal end of the arm contacts the first end of the cam when the arm is in the locking position, translating the cam into the second position.

17. The assembly of claim 16, wherein the cam is spring-biased to the first position.

18. The assembly of claim 17, further comprising open indicia on the cam adjacent the locking indicia, the open indicia viewable through the viewing window when the cam is in the first position.

19. The assembly of claim 18, wherein the spring moves the cam into the first position when the arm is in the open position.

20. The assembly of claim 5, wherein the viewing window is visible with the strong arm in either the open position or the locked position.
